(19) United States
(12) Patent Application Publication
(10) Pub. No.: US 2016/0280157 A1
(43) Pub. Date: Sep. 29, 2016

(54) OUTER COVER MATERIAL FOR WIRE HARNESS, AND ROUTING STRUCTURE FOR WIRE HARNESS

(71) Applicant: SUMITOMO WIRING SYSTEMS, LTD., Mie (JP)

(72) Inventors: Shinji KATOU, Yokkaichi, Mie (JP); Yoshikazu SAKAKIBARA, Yokkaichi, Mie (JP)

(21) Appl. No.: 14/916,285

(22) PCT Filed: Aug. 19, 2014
(86) PCT No.: PCT/JP2014/071608

§ 371 Date: Apr. 21, 2016

(30) Foreign Application Priority Data
Sep. 5, 2013 (JP) 2013-183927

(51) Int. Cl. B60R 16/02; H02G 3/04; H01B 7/00; H01B 7/17

(52) U.S. Cl. CPC B60R 16/0215; H01B 7/17; H02G 3/0462; H01B 7/0045

(57) ABSTRACT

A caterpillar-shaped outer cover material for a wire harness is improved. An outer cover material for a wire harness that is made of an injection molded article and is caterpillar-shaped includes coupling plates that are provided along two edges of a band-shaped central plate in a width direction so as to protrude in parallel to each other. One of the coupling plate has locking claws that are provided at intervals in a length direction protruding from an end of that coupling plate, the other of the coupling plates has locked frames to which the locking claws are respectively locked and coupled, and that protrude from an end of that coupling plate, and the central plate has folding lines constituted by two grooves that extend in the length direction at a distance in the width direction, and has slits extending in the width direction that are provided at intervals in the length direction. Furthermore, a tape wound piece to which a wire harness is to be fixed is provided at least one of two ends, in the length direction, of the one coupling plate or a member arranged between the folding lines of the central plate, and a clip for being latched to a fixation material protrudes from at least the other end.

### TECHNICAL FIELD

The present invention relates to an outer cover material for a wire harness and a routing structure of a wire harness covered with this outer cover material, and relates in particular to an improvement of a caterpillar-shaped outer cover material, and an application of a wire harness that is covered with this outer cover material to a wire harness routing structure for sliding seats.

### BACKGROUND ART

Wire harnesses that are routed from the floor side to a sliding seat installed in an automobile, or wire harnesses that are routed between doors and the vehicle body are repeatedly moved in accordance with the forward and backward movement of the sliding seat or opening and closing movement of the doors, and thus these wire harnesses often have an excess length, and the excess length is absorbed by the wire harnesses being bent and moved in an excess length accommodating section provided on a wire harness routing path.

Outer cover materials for the wire harnesses that are repeatedly bent and operated in conjunction with the seat and the doors need to be flexible. Conventionally, JP 2008-25775A (Patent Document 1) provides a caterpillar-shaped outer cover material that is formed by providing a band-shaped plate processed by extrusion molding with folding lines in a length direction thereof and cuts in a width direction thereof, and folding and assembling the band-shaped plate as a flexible tubular body.

The caterpillar-shaped outer cover material for a wire harness of Patent Document 1 has a configuration shown in FIGS. 8(A) and 8(B), and includes a band-shaped flat plate 100 that is made of a resin and has folding lines 101, cuts 102, latch holes 103 on one end side in the width direction Y, and latch protrusions 104, which are to be inserted into the holes 103, on the other end side. By folding the band-shaped flat plate 100 at the folding lines 101 and inserting and coupling the latch protrusions 104 into and with the latch holes 103, the band-shaped flat plate 100 is made square tubular as shown in FIG. 8(B) and is made flexible with the cuts 102 that are provided at intervals in the length direction.

A wire harness is set in the outer cover material in the developed state, and then the outer cover material is assembled into a square tube so as to cover the wire harness. The outer cover material is configured, when the wire harness covered with the outer cover material is routed to a bending position, to be able to follow bending of the wire harness by coupling parts of the outer cover material at two ends in the width direction being positioned on the inner circumferential side and the cuts 102 on the outer circumferential side opening and closing.

Conventional corrugated tubes that are generally used as an outer cover material for a wire harness meander while being curved on both the outer circumferential side and the inner circumferential side, and it is difficult to control the directions of the curves. In contrast thereto, the outer cover material of Patent Document 1 has advantages, such as that the outer cover material is curved only on the outer circumferential side, that the direction of the curve can be controlled, and that the outer cover material can be inserted through the excess length accommodating case in a stable form due to its square tubular shape.

On the other hand, the applicant of the present invention has provided, in JP 2011-162134A (Patent Document 2), a structure as shown in FIGS. 9(A) and 9(B), serving as an apparatus for routing a wire harness to a sliding seat. In the structure, a wire harness 200 is inserted into a space of a seat rail 201 to which wheels of the sliding seat are to be fitted so as to be movable, an excess length accommodating case 203 for the wire harness is arranged at a front end of the seat rail 201, and the wire harness 200 is U-turned in the excess length accommodating case 203 and is drawn out therefrom so as to be connected to a floor harness.

In this wire harness routing apparatus, the wire harness 200 to be connected to a floor harness that is routed on the floor of an automobile is fixed to the excess length accommodating case 203 arranged on the floor side or to the floor by a clamp 205 in the vicinity of an outlet of the excess length accommodating case 203. This wire harness 201 fixed to the floor side needs to be routed to the sliding seat via the excess length accommodating case 203 and the seat rail 201, and be connected to a seat harness that is wired in the sliding seat on the bottom side.

As shown in FIG. 10, the routing of the wire harness 200 from the floor side to the sliding seat side is performed by raising the front end of a seat 301 of a sliding seat 300 so as to incline the front part, and setting the seat 301 to a position at which an operation for attaching the wire harness 200 to a bottom 301f of the seat 301 can be performed. The distance between the seat bottom 301f of the sliding seat and a vehicle body floor 400 is longer than the distance at the normal position at which the seat 301 of the sliding seat 300 is horizontal. Accordingly, the wire harness 200 needs to have a length as long as it is needed in the attaching operation, namely, a length that is much longer than the necessary length in actual use when the sliding seat is returned to the normal position.

### CITATION LIST

### Patent Documents

Patent Document 1: JP 2008-25775A

Patent Document 2: JP 2011-162134A

### SUMMARY OF INVENTION

### Technical Problem

With the outer cover material of Patent Document 1, after the band-shaped flat plate is continuously formed by extrusion molding, it is necessary to form the cuts 102 by pressing, the latch holes 103 at intervals in the length direction by punch processing, and the latch protrusions 104 by punching, thus causing the problem that there are a large number of steps of post-processing.

Furthermore, the band-shaped resin flat plate 100 that is formed by extrusion molding is made of polypropylene in order to facilitate the post-processing, but there is the problem that when the band-shaped flat plate made of polypropylene is bent into a square tube, the assembled square tube has weak shape retainability. In order to improve the shape retainability, it is preferable to mix an elastomer or the like with the polypropylene, but in this case, there is the problem that the material cost increases. Furthermore, since, after the band-shaped flat plate is assembled into the square tube, latching is achieved only by the latch protrusions being inserted into the latch holes, the latch force is low, and the latching may be solved by application of a large bending force, possibly causing the wire harness provided inside to project outward.

Furthermore, as described in Patent Document 2, if the wire harness 200 that is to be routed to a sliding seat is inserted through the excess length absorbing case 203, the length of the wire harness 200 will need to be longer because the length of the wire harness that is drawn out from the excess length accommodating case 203 during the operation for attaching the wire harness to the sliding seat is limited. Accordingly, the excess length accommodating case 203 increases in size, and this will cause problems regarding an installation space and an increase in cost, and also the wire harness 200 having a long length will cause the problem that it is likely to interfere with peripheral devices.

The present invention was made in view of the above-described problems, and it is a first object of the present invention to provide a caterpillar-shaped outer cover material that does not require post-processing, and has enhanced shape retainability in the state of being assembled into a square tube even if it is made of an inexpensive material, the outer cover material being such that an operation for coupling two ends of the outer cover material in a width direction is facilitated, the coupling force is strong, and the ends are not easily uncoupled.

Furthermore, it is a second object of the present invention to eliminate the need of a wire harness for a sliding seat having a long wire length for being attached to the sliding seat, and to achieve a simple attaching operation.

### Solution to Problem

In order to solve the above-described problems, according to a first aspect, an outer cover material for a wire harness that is made of an injection molded article and is caterpillar-shaped, wherein coupling plates that are provided along two edges of a band-shaped central plate in a width direction protrude in parallel to each other, one of the coupling plate has locking claws that are provided at intervals in a length direction protruding from an end of that coupling plate, the other of the coupling plates has locked frames to which the locking claws are respectively locked and coupled, and that protrude from an end of that coupling plate, and the central plate has folding lines constituted by two grooves that extend in the length direction at a distance in the width direction, and has slits extending in the width direction that are provided at intervals in the length direction, wherein a tape wound piece to which a wire harness is to be fixed is provided at at least one of two ends, in the length direction, of the one coupling plate or a member arranged between the folding lines of the central plate, and a clip for being latched to a fixation material protrudes from at least the other end, and wherein the central plate is folded along the folding lines so as to have a U-shaped cross-section, the ends of the coupling plates on both sides are overlapped with each other so that the outer cover material is square tubular, and the locking claws and the locked frames of the coupling plates on both sides are locked and coupled to each other.

As described above, the outer cover material of the present invention is formed by injection molding, and thus the folding lines can be formed during the injection molding by providing the grooves and forming thin-walled parts, and the slits, the locking claws, and the locked frames that are provided at intervals in the length direction can also be formed during the injection molding, making it possible to eliminate the need of post-processing after the injection molding. Furthermore, the tape wound piece can be provided protruding from the end of the outer cover material in the length direction, and the end of the wire harness that is inserted into the outer cover material can be fixed thereto by winding a tape around it. Also, the clip can be provided protruding from at least one end in the length direction, and by inserting and latching the clip into the latch hole formed in the fixation material such as a vehicle body floor, it is possible to fix the wire harness to the floor side.

Furthermore, since the coupling plates on both sides that have the locking claws and the locked frames are provided protruding from the central plate by injection molding, the outer cover material has shape retainability in the state of being assembled into a square tube and being locked and coupled, making it possible to prevent easy unlocking.

Furthermore, since the shape retainability is enhanced by injection molding, it is not necessary to use a resin material in which an expensive elastomer is mixed with polypropylene, and the outer cover material can be made only of inexpensive polypropylene, making it possible to reduce the material cost.

Preferably, the slits are curved on an intermediate first member between the two folding lines of the central plate of the main body, and each slit has, on second and third members that sandwich the first member, small circles on ends of the slit that are in contact with the coupling plates that constitute a fourth member.

By providing the small circles on both ends of the slit, it is possible to prevent a crack from occurring from the ends of the slit. Furthermore, the small holes can function also as latch holes for a connection member that will be described later.

Preferably, the tape wound pieces are provided on both ends, in the length direction, of the outer cover material for a wire harness, the tape wound piece on one end is substantially T-shaped so that the wire harness can be branched and fixed thereto by winding a tape around it, the tape wound piece on the other end is tongue-shaped so that an electric wire group of the wire harness can be fixed altogether thereto by winding a tape around it, and the clip is also provided on the end side of the outer cover material from which the tongue-shaped tape wound piece protrudes.

Preferably, the T-shaped tape wound piece at one end of the outer cover material in the length direction is provided such that the longitudinal part of the T-shape protrudes from one end of the coupling plate in the length direction, and branch parts of the wire harness in two directions can respectively be fixed to the lateral part of the T-shape at the end by winding tapes around it.

A wire harness for supplying power to an electric component mounted on a sliding seat that is installed in an automobile has a configuration in which a seat harness that is routed in a sliding seat is connected to a floor harness that is routed along the floor of the automobile. There are three types of connection between the seat harness and the floor harness, namely, connection in which the seat harness is extended and connected to the floor harness, connection in which inversely a branched wire that is branched from the trunk wire of the floor harness is extended and connected to the seat harness, and connection in which an intermediate wire harness is provided between the seat harness and the floor harness and both ends of the intermediate wire harness are respectively connected to the seat harness and the floor harness.

In all the types, the part of the seat harness that is provided in the inside of the sliding seat has a configuration in which a wire harness that is inserted into the seat from the outside of the seat is branched in two directions.

Accordingly, as described above, it is preferable that the tape wound piece that is provided as an integral part of the outer cover material for a wire harness be T-shaped, and branch parts of the wire harness respectively be fixed thereto so as to be guided in the branch directions.

Furthermore, it is preferable for the tongue-shaped tape wound piece that is provided at the other end of the outer cover material for a wire harness in the length direction to protrude in the shape of a tongue from the end in the length direction of the intermediate side between the folding lines on both sides of the central plate, the wire harness that is drawn out from the outer cover material is fixed to the tape wound piece, and the clip having blade-shaped latching parts protrudes from the end side outer surface of the intermediate piece from which the tongue-shaped tape wound piece protrudes.

When the outer cover material for covering a wire harness for a sliding seat is used for covering, it is preferable for the clip provided at the other end of the outer cover material to be directly inserted and latched into a latch hole formed in a vehicle body panel, and thereby the wire harness is positioned and fixed to the vehicle body panel.

Note that when the wire harness is covered with the outer cover material, and is inserted through an excess length accommodating case, it is also possible that the clip is provided in the vicinity of the outlet of the excess length accommodating case, and is inserted and latched into the latch hole. Note that the excess length accommodating case is fixed to the floor or the sliding seat.

Note that when the outer cover material of the present invention is mounted on a wire harness that is not a wire harness for a sliding seat, clips for being latched to the fixation material may be provided at both ends of the outer cover material in the length direction, or a tape wound piece for a wire harness may be provided protruding only from one end side in the length direction.

According to a second aspect of the present invention, an apparatus for routing a wire harness for a sliding seat is provided in which the outer cover material according to the first aspect of the present invention is assembled into a square tube and covers a wire harness, the wire harness that is drawn out from the square tube is fixed to the tape wound pieces on two ends of the outer cover material in the length direction by winding tapes around them, the wire harness covered with the outer cover material is routed so as to meander between a sliding seat and a vehicle body floor without passing through a guide member that includes an excess length electric wire accommodating case, and the clip that protrudes from the end of the outer cover material in the length direction is inserted and latched into a latch hole of the vehicle body floor.

Preferably, a branch part of the wire harness is attached to the T-shaped tape wound piece on one end of the outer cover material by winding a tape around it, and a connector connected to the end side of the branch part is connected to a connector at a terminal of a seat harness routed in the sliding seat.

As described above, in the routing structure of a wire harness for a sliding seat according to the second aspect of the present invention, the wire harness is not inserted through the excess length absorbing case disclosed in Patent Document 2, other guide rails, or the like, and meanders between the sliding seat and the vehicle body floor in the state of being only covered with the outer cover material.

Accordingly, with the configuration in which no other guide means including an excess length electric wire accommodating case is provided and the wire harness is only covered with the outer cover material for flexibly surrounding the wire harness, when the seat of the sliding seat is inclined upward and the wire harness is attached, the part of the wire harness that is inserted into the excess length accommodating case is not restricted, and the excess length part of the wire harness can be extended to the length needed for the attaching, eliminating the need of the wire harness having an excessively long length. Also, it is possible to improve wire harness routing operability between the sliding seat and the floor, and since guide means including an excess length accommodating case is no longer necessary, it is possible to reduce the numbers of components and attaching operations, achieving thereby a significant reduction in cost.

Furthermore, the outer cover material has shape retainability and predetermined strength since it is made of an injection molded article, making it possible to sufficiently protect the wire harness from an external interference material.

### Advantageous Effects of Invention

The outer cover material for a wire harness according to a first aspect of the present invention includes the coupling plates that are bent on both sides of the band-shaped central plate made of an injection molded article. The outer cover material is made square tubular by folding the central plate at the folding lines thereof that are constituted by the grooves, and thus has shape retainability in the state of being square tubular, and it is possible to make the outer cover material only of polypropylene without mixing an expensive elastomer with inexpensive polypropylene. Also, post-processing after molding is not needed, and manufacturing is highly efficient. Also, since injection molding is used, the tape wound piece that is provided at the end of the outer cover material in the length direction and to which the wire harness can be fixed by winding a tape around it, and the clip that is fixed to a fixation material such as the vehicle body panel can be provided as an integral part. Therefore, the wire harness can easily be positioned and fixed without an increase in the number of components.

Furthermore, by covering the wire harness with the outer cover material of the first aspect of the present invention, the outer cover material made of an injection molded article has strength and shape retainability, and thus the wire harness can be protected from an external interference material, and can be retained in the routed state, such as in the state of meandering. Therefore, the wire harness that is to be routed between the sliding seat installed in an automobile and the vehicle body floor can meander in the state of being only covered with the outer cover material and can be routed. As a result, wire harness attaching operability is improved, and a wire harness guiding apparatus including an excess length accommodating case is no longer necessary, making it possible to reduce the component cost.

### BRIEF DESCRIPTION OF DRAWINGS

FIG. 1 illustrates an outer cover material according to an embodiment of the present invention, with FIG. 1(A) being a perspective view before assembling, FIG. 1(B) being an enlarged view of a part of FIG. 1(A), and FIG. 1(C) being a perspective view of the outer cover material that is assembled into a square tube.

FIG. 2(A) is a partially enlarged plan view of the outer cover material, FIG. 2(B) is a cross-sectional view taken along the line B-B of FIG. 2(A), and FIG. 2(C) illustrates a folding step.

FIG. 3(A) is a front view of the outer cover material from one end side, FIG. 3(B) is a diagram illustrating tape wound pieces at two ends of the outer cover material, and FIG. 3(C) is a cross-sectional view of a clip that is provided on the outer cover material.

FIG. 4(A) is a perspective view illustrating an entire sliding seat to which a wire harness covered with the outer cover material is attached, and FIG. 4(B) is a cross-sectional view of the main part of a routing structure for the wire harness attached to the sliding seat.

FIG. 5(A) is a diagram illustrating the state during operation of attaching the wire harness to the sliding seat, and FIG. 5(B) is a diagram illustrating the state after the attaching.

FIG. 6 is a diagram illustrating the state in which the wire harness attached to the sliding seat is displaced in accordance with movement of the sliding seat.

FIG. 7 is a perspective view illustrating a modification of the routing structure of the wire harness covered with the outer cover material.

FIGS. 8(A) and 8(B) are diagrams illustrating a conventional example.

FIGS. 9(A) and 9(B) are diagrams illustrating another conventional example.

FIG. 10 is a diagram illustrating conventional problems.

### DESCRIPTION OF EMBODIMENTS

Hereinafter, embodiments of the present invention will be described with reference to the drawings.

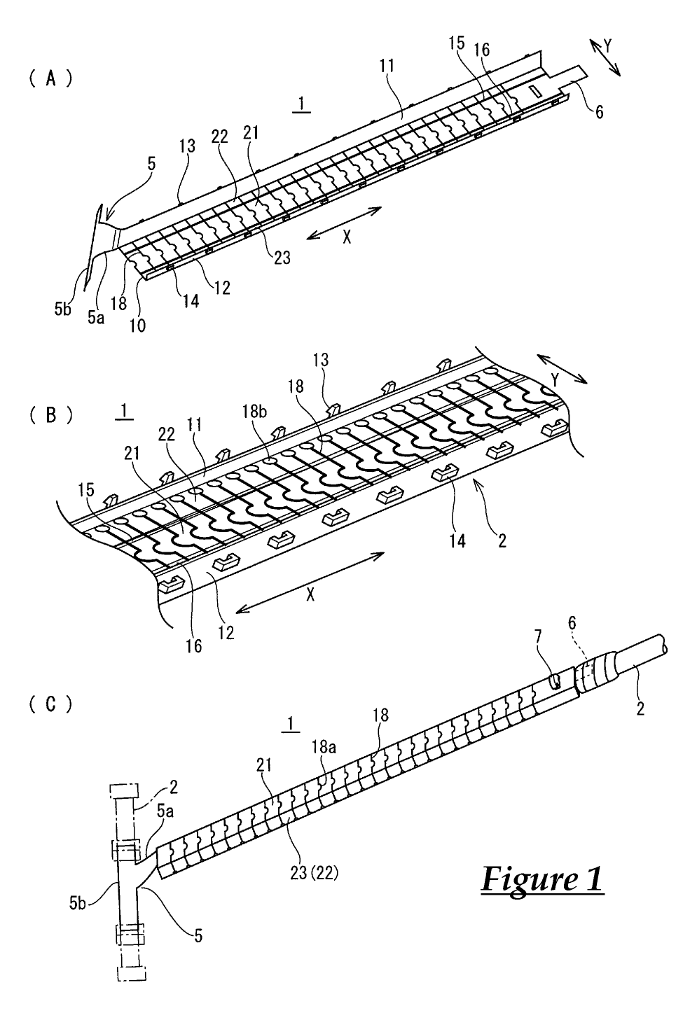

FIGS. 1 to 3 show an embodiment of an outer cover material for a wire harness according to the present invention.

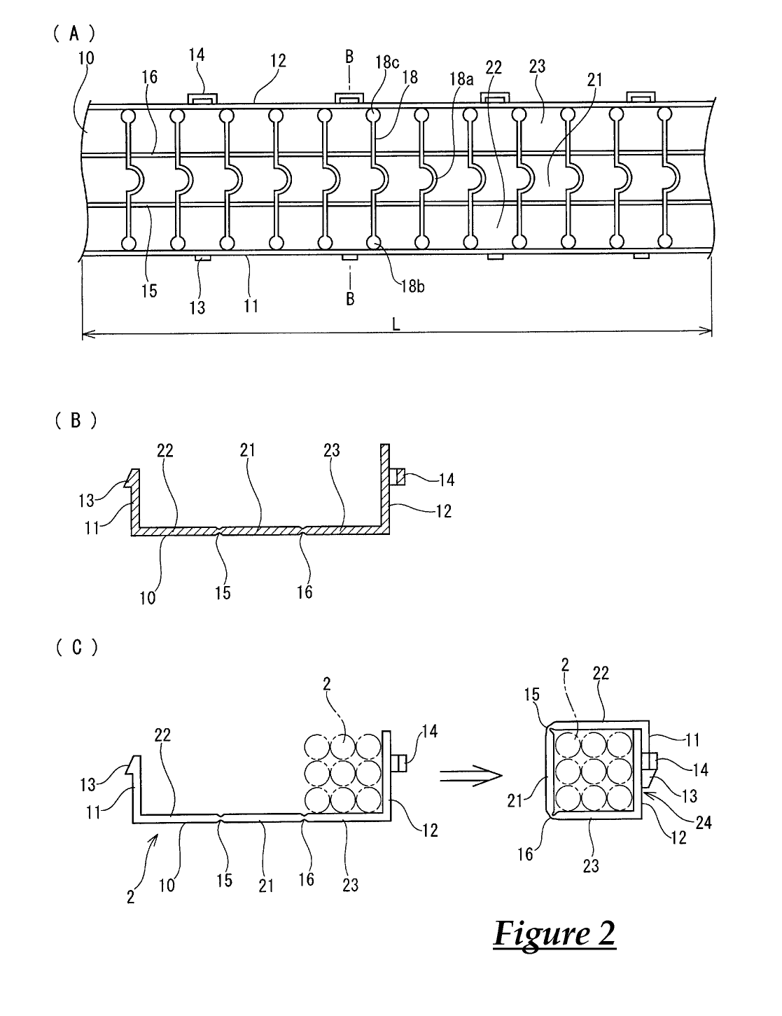

An outer cover material 1 shown in FIGS. 1 and 2 is made of an injection molded article, namely, polypropylene in the present embodiment.

The outer cover material 1 is bent in a state in which a wire harness 2 is set therein and is assembled into a square tube so as to externally cover the wire harness 2. The outer cover material 1 is caterpillar-shaped so as to be flexible by slits 18 provided at intervals in the length direction opening and closing.

The outer cover material 1 has a pair of coupling plates 11 and 12 along two edges, in a width direction Y, of a band-shaped central plate 10, the coupling plates 11 and 12 being bent at substantially 90 degrees and protruding parallel to each other. Locking claws 13 protrude from an end of one coupling plate 11 at intervals in a length direction X, and locked frames 14 protrude from an end of the other coupling plate 12 to which the locking claws 13 are locked and coupled.

The central plate 10 has folding lines 15 and 16, which are made of two grooves that extend in the length direction X and are provided at a distance in the width direction Y. An intermediate surface between the two folding lines 15 and 16 is referred to as “first member 21”, a surface between the folding line 15 and the coupling plate 11 is referred to as “second member 22”, and a surface between the folding line 16 and the coupling plate 12 is referred to as “third member 23”.

As shown in FIG. 2(C), by folding the central plate 10 along the folding lines 15 and 16 so as to have a U-shaped cross-section, the ends of the coupling plates 11 and 12 on both sides are overlapped with each other, so that the outer cover material 1 is assembled into a square tube. In this state, the locking claws 13 of the coupling plate 11 are inserted and latched into the locked frames 14 of the coupling plate 12 so that the coupling plates are locked and coupled to each other, thereby retaining the square tube. The coupling plates 11 and 12 that are locked and coupled to each other form a fourth member 24 that is opposite to the first member 21.

Furthermore, the central plate 10 has slits 18 that are provided at intervals in the length direction X and extend over the entire width in the width direction Y. The slits 18 have a recess-protrusion part obtained by forming the straight line on the first member 20 between two folding lines 15 and 16 into an arc-shaped slit 18a, that is, one side of that member that is adjacent to another member in the length direction is made to protrude in the arc shape, and the other side of that member is recessed into the arc shape. Furthermore, small circles 18b and 18c are provided on two ends of each slit 18 that are in contact with the coupling plates 11 and 12.

As described above, since the slits 18 extending in the width direction Y are provided at intervals in the length direction X on the first to third members 20 to 23 but not on the fourth member 24 formed by the coupling plates 11 and 12 being locked and coupled to each other, the slits 18 can open and close when the fourth member 24 are on the inner circumferential side, and the outer cover material 1 can be curved by changing its curvature factor and can take on the caterpillar shape as described above.

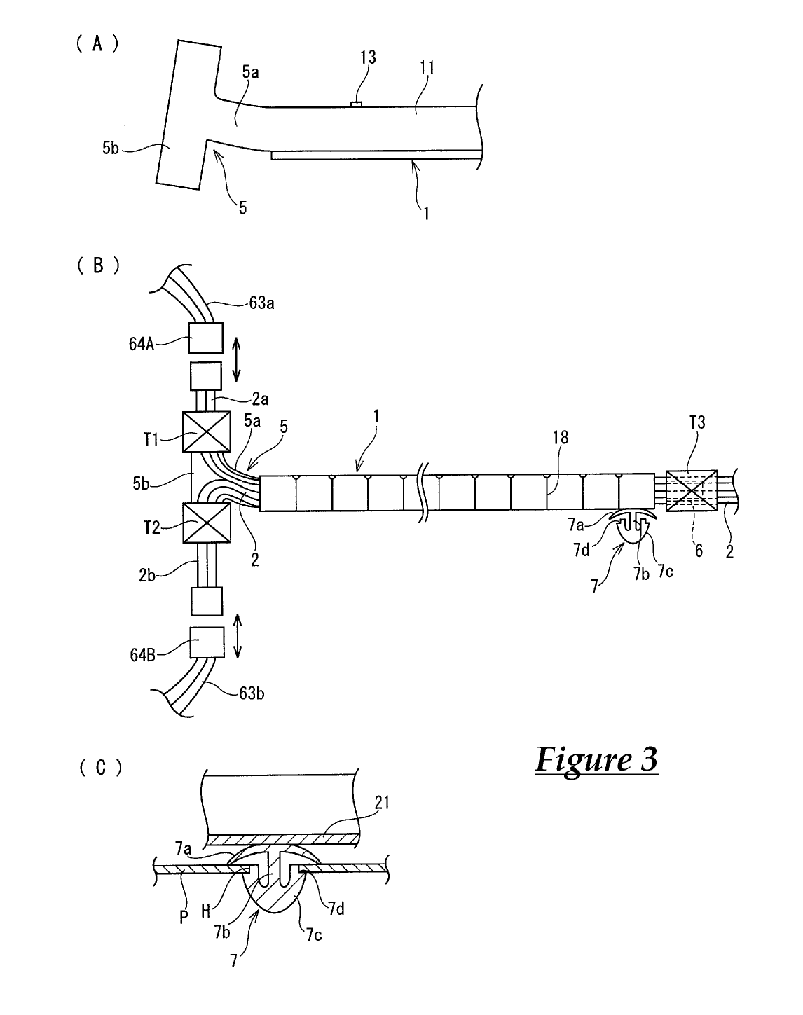

As shown in FIGS. 1 and 3, a T-shaped tape wound piece 5 protrudes from an end of the coupling plate 11 on one end of the outer cover material 1 in the length direction. A longitudinal part 5a of the T-shape of the tape wound piece 5 protrudes from the end of the coupling plate 11, and a lateral part 5b is provided in an orthogonal direction at the end of the longitudinal part 5a. As shown in FIG. 3(B), branch parts 2a and 2b of the wire harness 2 that are drawn out in two directions from the outer cover material 1 can be fixed to the tape wound piece 5 by winding tapes T1 and T2 respectively around it.

Also, on the other end of the outer cover material 1 in the length direction, a tape wound piece 6 protrudes in the shape of a tongue from an end in the length direction of the first member 21, which is an intermediate side between the folding lines 15 and 16 on both sides of the central plate 10. A group of electric wires of the wire harness that are drawn out from the outer cover material 1 can be fixed altogether to the tape wound piece 5 by winding a tape T3 around it.

A clip 7 for being latched to a vehicle body panel protrudes from the outer surface at the end of the first member 21 of the central plate 10 from which the tape wound piece 5 protrudes. The clip 7, as shown enlarged in FIG. 3(C), has a dish part 7a that protrudes from the outer surface of the central plate 10, and a shaft part 7b that protrudes from the center of the dish part 7a. Blade parts 7c are provided so as to be folded back to two sides from the top of the shaft part 7b, and each of the pair of blade parts 7c has, at the end thereof, a step-like latching part 7d. The clip 7 is fixed by the blade parts 7c being inserted into a latch hole H formed in a floor panel P of the vehicle body, and the step-like latching parts 7d being latched to the inner circumferential surface of the latch hole H.

A method for covering the wire harness 2 with the outer cover material 1 will be described next.

As shown in FIG. 2(C), first, the wire harness 2 denoted in alternate long and short dash lines is placed onto the third member 23 in the state in which the central plate 10 is flat without being folded.

Then, the central plate 10 is folded at the folding lines 15 and 16 so as to surround the wire harness 2. In this state, the coupling plates 11 and 12 are positioned on a side of the wire harness 2, and a square tube covering the wire harness 2 is achieved.

Then, the locking claws 13 of the coupling plate 11 are inserted and latched into the locked frames 14 of the coupling plate 12 so that the coupling plates are locked and coupled to each other.

As described above, the wire harness 2 is covered with the outer cover material 1 that is square tubular, and then, as shown in FIG. 3(B), the wire harness 2 that is drawn out from one end in the length direction is branched into two parts. One branch part 2a is fixed to one side of the lateral part 5b of the T-shaped tape wound piece 5 by winding the tape T1 around it, and the other branch part 2b is fixed to the other side of the lateral part 5b by winding the tape T2 around it.

Furthermore, the wire harness 2 that is drawn out from the other end of the outer cover material 1 in the length direction is fixed to the tongue-shaped tape wound piece 6 by winding the tape T3 around it.

As described above, the wire harness 2 is covered with the outer cover material 1 assembled into a square tube, and the outer cover material 1 and the wire harness 2 are fixed to each other by winding the tapes around the wire harness 2 and the tape wound pieces 5 and 6 at two ends of the outer cover material 1 in the length direction.

As shown in FIG. 1(C), since the outer cover material 1 has the slits 18 at a given interval in the length direction on three sides of the square tube, namely, the first to third members 21 to 23 but not on the fourth member 24 formed by the coupling plates 11 and 12 being coupled to each other, the outer cover material 1 can thus be bent by the slits 18 opening and closing. Therefore, when covering the wire harness 2 that is bent and moved in conjunction with movement of a sliding seat, a side door, a sliding door, or the like, the outer cover material 1 can smoothly follow the bending of the wire harness 2.

Also, since the outer cover material 1 that is made of a resin molded article has shape retainability in the state of being assembled into a square tube and also has strength, the outer cover material 1 can protect the wire harness against an external interference material.

Furthermore, since the tape wound pieces are provided at both ends of the outer cover material 1, it is possible to wind the tapes on the wire harness 2 that is inserted into the outer cover material 1 at both ends of the outer cover material 1 in the length direction, and to reliably position and fix the outer cover material 1 at a predetermined position of the wire harness 2.

Furthermore, since the clip serving as an integral part of the outer cover material protrudes therefrom, it is not necessary for the wire harness to be provided with a band clip or a substrate-shaped clip on which a tape is wound, making it possible to eliminate the need of the separate clip, and to reduce the component cost and labor for providing it.

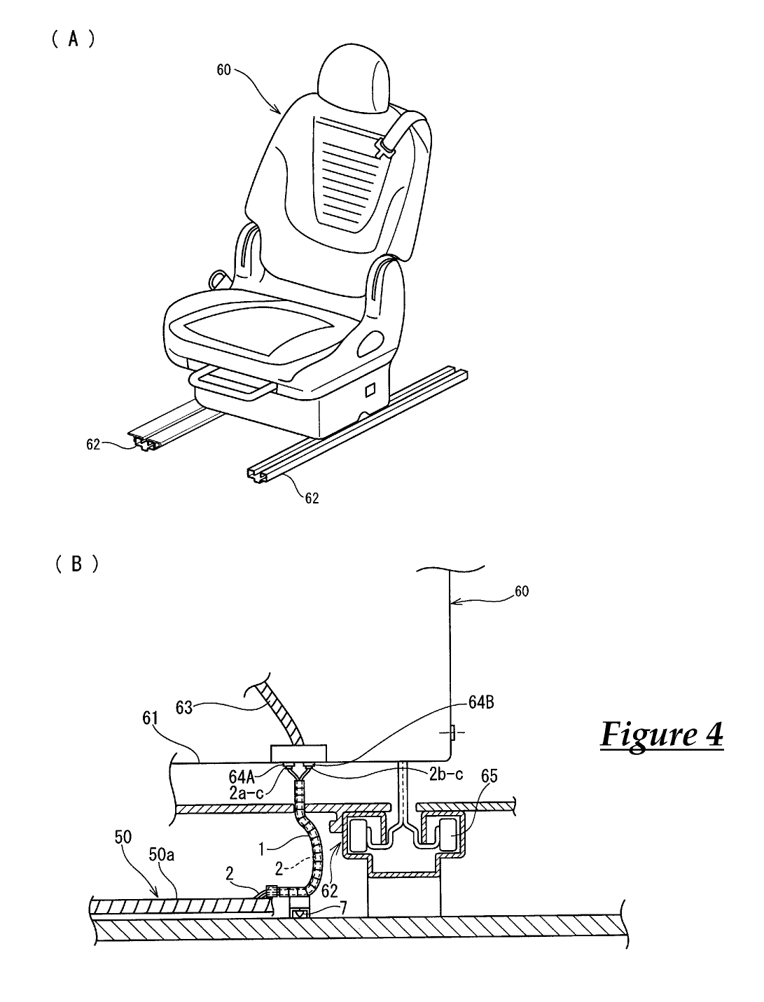

FIGS. 4 to 6 show an embodiment of a wire harness routing apparatus for attaching the wire harness 2 covered with the outer cover material 1, the wire harness 2 serving as a wire harness for supplying power to a sliding seat 60 that is to be installed in an automobile.

As shown in FIGS. 4(A) and 4(B), a wire harness 50 is routed to the sliding seat 60 from the floor side in order to supply power to an electric component (not shown) mounted on the sliding seat 60 that is to be installed in an automobile. Seat rails 62 are installed on the floor side of the lower surface of the sliding seat 60 and wheels 65 that are arranged at leg parts of the sliding seat 60 are fitted to the seat rails 62 so as to be movable.

A seat harness 63 is routed in the inside of the seat 61 of the sliding seat 60, and is arranged at the bottom of the seat 61 by connecting connectors 64A and 64B respectively to terminals 63a and 63b (shown in FIG. 3(B)) that are branched from the seat harness 63.

On the other hand, in the present embodiment, branched wires branched from a trunk wire 50a of the floor harness 50 are put together as a wire harness 2 covered with the outer cover material 1. The wire harness 2 is routed to the sliding seat 60 from the floor side, and connectors 2a-C and 2b-C that are respectively connected to terminals of the branch parts 2a and 2b on the terminal side of the wire harness 2 are fitted and electrically connected to the connectors 64A and 64B connected to the terminals of the seat harness 63.

Note that the wire harness 2 covered with the outer cover material 1 may be separated from the branch wires of the floor harness, and may be connected thereto using connectors.

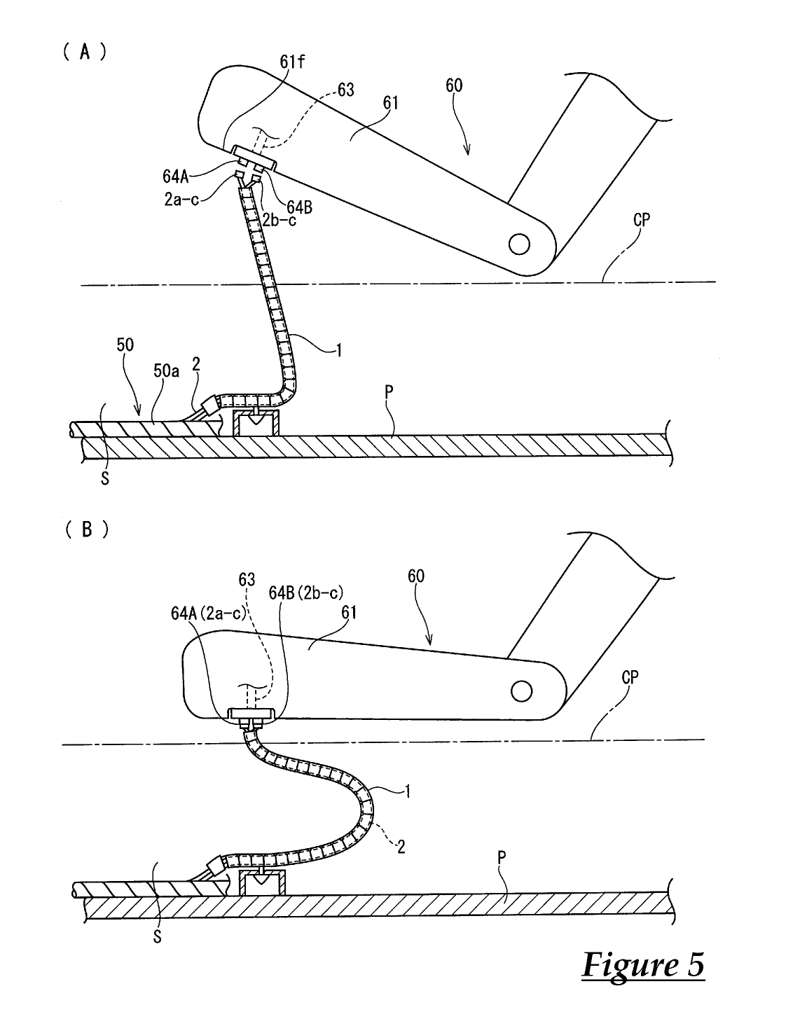

As shown in FIG. 5(A), an attaching operation in which the wire harness 2 branched from the floor harness 50 is covered with the outer cover material 1, and an end of the wire harness 2 drawn out from the outer cover material 1 is connected, using the connectors, to the terminal of the seat harness 63 on the bottom side 61f of the seat 61 of the sliding seat 60 is performed in the state in which the front end of the seat 61 of the sliding seat 60 is raised, and the seat 61 is inclined.

Since, as described above, the seat 61 of the sliding seat 60 is inclined during the operation for attaching the wire harness 2 covered with the outer cover material 1 to the sliding seat 60, the distance between the bottom 61f of the seat 61 and the floor panel P is longer than when the seat 61 is returned to the normal position that is shown in FIG. 5(B). Therefore, during the operation for attaching the wire harness to the sliding seat, the wire harness 2 that is routed therebetween needs to have a long length.

In contrast, in the state shown in FIG. 5(B) in which the sliding seat 60 is returned to the normal position, the wire harness 2 has a length as long as it is routed while meandering in the U-shape in a space S between a vehicle interior floor material (carpet material) CP and the floor panel P. Because the wire harness 2 is not inserted through an excess length absorbing case as disclosed in Patent Document 2, there is no member for restricting meandering of the wire harness 2. Therefore, the wire harness 2 can extend substantially straight to the bottom side of the seat 61 of the sliding seat 60 as shown in FIG. 5(A). In this state, the length of the wire harness 2 can be set to a length sufficient for the branched terminal side reaching the bottom of the seat 61. The connectors 2a-C and 2b-C connected to the terminal side can comfortably be fitted to the connectors 64A and 64B of the terminals of the seat harness 63 on the seat 61 side.

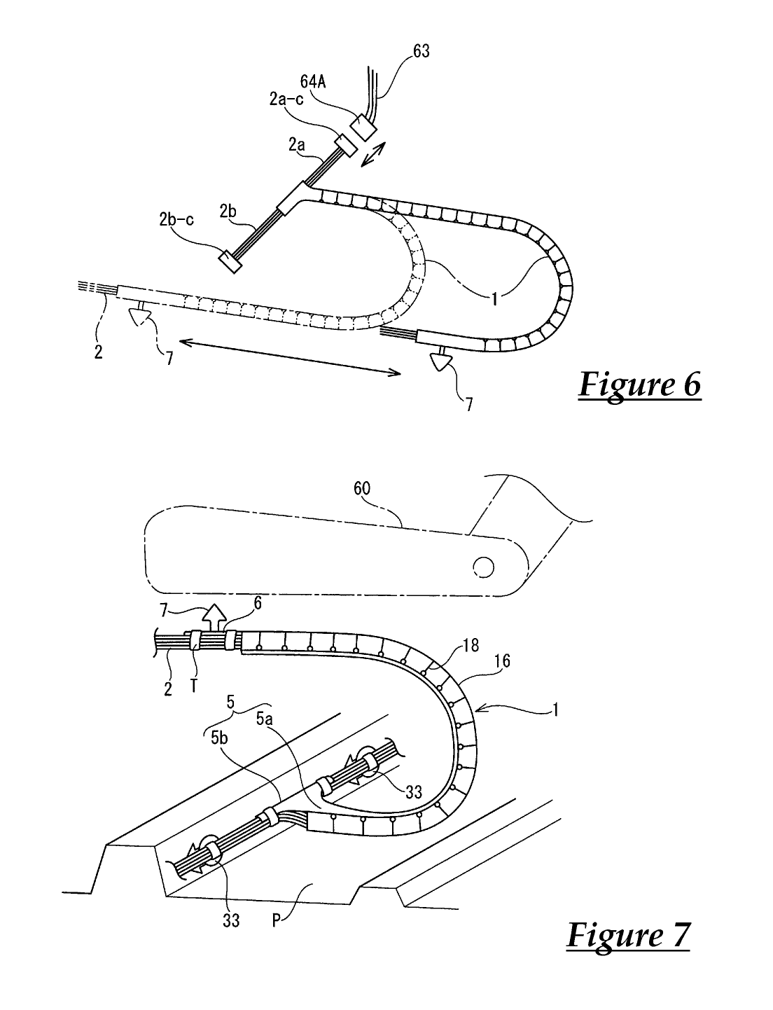

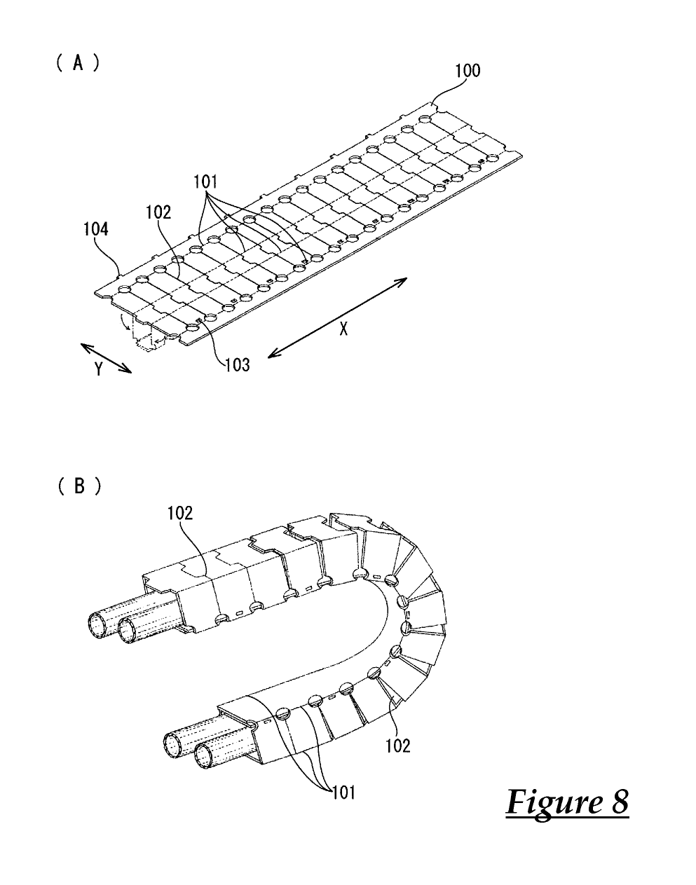

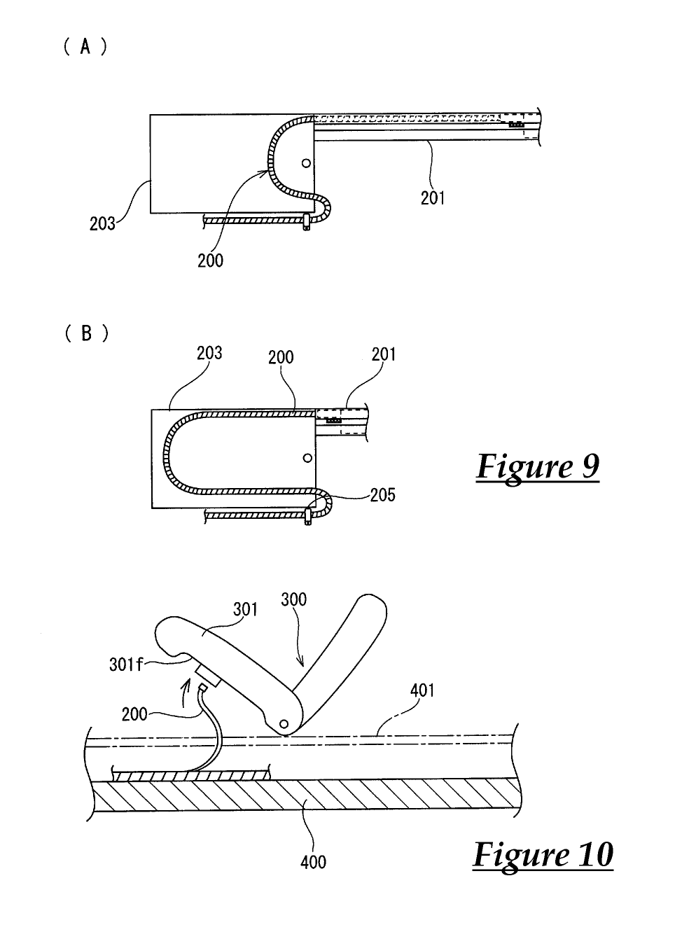

As described above, when the wire harness 2 and the seat harness 63 are connected to each other using the connectors, and then the seat 61 of the sliding seat 60 is returned to the original horizontal state as shown in FIG. 5(B), the wire harness 1 covered with the outer cover material 1 can meander while being turned in the U-shape in the space S between the seat 61 and the floor panel P, as shown in FIG. 6. Also, as described above, the outer cover material 1 has shape retainability, and thus the outer cover material 1 can be retained in the U-shape without hanging down.

FIG. 6 shows how a connection position in the sliding seat at which the terminal connector 64A of the seat harness 63 and the connectors 2a-c and 2b-c of the wire harness are connected to each other is set as a fixed position, and a position to which the clip 7 is fixed to the vehicle body is moved, that is, the connector connection side is moved according to the movement of the sliding seat, and a position on the vehicle body side to which the clip 7 is fixed is fixed. The state indicated by the solid lines in FIG. 6 is the state when the sliding seat is retreated, and the state indicated by the alternate long and short dash lines is the state when the sliding seat is advanced.

Accordingly, by covering a wire harness that is routed to the sliding seat with the outer cover material 1, it is possible to eliminate the need of an excess length absorbing case or the like, and thus to ensure a length necessary for attaching the wire harness, eliminating the need of an excessively long wire harness. Moreover, there is an advantage that the operation for attaching the wire harness to a sliding seat is simplified and operability is thus improved.

FIG. 7 shows a modification in which the length direction of the outer cover material 1 that covers the wire harness 2 is inverted with respect to that in the embodiment shown in FIGS. 4 to 6.

In the modification, the T-shaped tape wound piece 5 provided on the outer cover material 1 is arranged on the side on which it is connected to the floor harness, and the tongue-shaped tape wound piece 6 is arranged on the side on which it is connected to the seat harness, and the wire harness 2 is fixed to them by winding tapes around them. Accordingly, the latching clip 7 that is provided on the tape wound piece 6 side is inserted and latched into the latch hole of the seat of the sliding seat.

Furthermore, the branch wires of the wire harness 2 on the tape wound piece 5 on the floor side are branched, and are respectively fixed thereto by winding tapes around them, and band clips 33 are respectively fastened to the branch wires, and are inserted and latched into the latch holes provided on the side surface of the step-like protrusion of the floor P, so that the wire harness is fixed to the floor side.

The longitudinal part 5a of the T-shape of the tape wound piece 5 protrudes from the end of the coupling plate 11, and a lateral part 5b thereof is provided in an orthogonal direction at the end of the longitudinal part 5a.

The present invention is not limited to the embodiments, and the wire harness covered with the outer cover material 1 of the present invention can suitably be used for a wire harness that is routed to a sliding door or a side door. LIST OF REFERENCE NUMERALS

1 Outer cover material

2 Wire harness

2a, 2b Branch part

5 T-shaped tape wound piece

6 Tongue-shaped tape wound piece

7 Clip

10 Central plate

11, 12 Coupling plate

13 Locking claw

14 Locked frame

15, 16 Folding line

18 Slit

18a Curved part

18b, 18c Small circle

60 Sliding seat

61 Seat

1. An outer cover material for a wire harness that is made of an injection molded article and is caterpillar-shaped, comprising:
a plurality of coupling plates that are provided along two edges of a band-shaped central plate in a width direction protrude in parallel to each other, one of the coupling plates has locking claws that are provided at intervals in a length direction protruding from an end of that coupling plate, the other of the coupling plates has locked frames to which the locking claws are respectively locked and coupled and that protrude from an end of that coupling plate, and the central plate has folding lines constituted by two grooves that extend in the length direction at a distance in the width direction and has slits extending in the width direction that are provided at intervals in the length direction;
a tape wound piece to which a wire harness is to be fixed is provided at at least one of two ends, in the length direction, of the one coupling plate or a member arranged between the folding lines of the central plate, and a clip for being latched to a fixation material protrudes from at least the other end; and
wherein the central plate is folded along the folding lines so as to have a U-shaped cross-section, the ends of the coupling plates on both sides are overlapped with each other so that the outer cover material is square tubular, and the locking claws and the locked frames of the coupling plates on both sides are locked and coupled to each other.

2. The outer cover material for a wire harness according to claim 1,
wherein the tape wound pieces are provided on both ends in the length direction the tape wound piece on one end is T-shaped so that the wire harness can be branched and fixed thereto by winding a tape around it, the tape wound piece on the other end is tongue-shaped so that an electric wire group of the wire harness can be fixed altogether thereto by winding a tape around it, and the clip is also provided on the end side of the outer cover material from which the tongue-shaped tape wound piece protrudes.

3. A method for routing a wire harness for a sliding seat, comprising the steps of:
assembling an outer cover material into a square tube and covering a wire harness, the wire harness that is drawn out from the square tube is fixed to tape wound pieces on two ends of the outer cover material in a length direction by winding tapes around them; and
routing the wire harness covered with the outer cover material so as to meander between a sliding seat and a vehicle body floor without passing through a guide member that includes an excess length electric wire accommodating case, and a clip that protrudes from one end of the outer cover material in the length direction is inserted and latched into a latch hole of the vehicle body floor.

4. The method for routing a wire harness for a sliding seat according to claim 3, further comprising:
attaching a branch part of the wire harness to a T-shaped tape wound piece on another end of the outer cover material by winding a tape around it, and connecting a connector connected to an end side of the branch part to a connector at a terminal of a seat harness routed in the sliding seat.
